(19) United States
(12) Patent Application Publication
(10) Pub. No.: US 2003/0034196 A1
(43) Pub. Date: Feb. 20, 2003

(54) Electric power steering system

(75) Inventors: Yasuo Shimizu, Wako (JP); Katsuji Watanabe, Wako (JP)

Correspondence Address: Alan H. MacPherson, MacPHERSON, KWOK & CHEN LLP, Suite 195E, 2001 Gateway Place, San Jose, CA, 95110, US

(73) Assignee: HONDA GIKEN KOGYO KABUSHIKI KAISHA, Tokyo (JP)

(21) Appl. No.: 10/223,926

(22) Filed: Aug. 19, 2002

(30) Foreign Application Priority Data
Aug. 20, 2001 (JP) PAT. 2001-249046

(51) Int. Cl. B62D 5/04

(52) U.S. Cl. 180/444

(57) ABSTRACT

In an electric power steering system comprising a worm speed reduction gear unit using an hourglass worm, a pitch diameter of the worm wheel is smaller than that of the hourglass worm. Therefore, when the transmission torque between the worm and worm wheel is relatively small, only one or two of the teeth of the worm wheel engage the worm, and a certain resiliency is produced in the meshing between the worm and worm wheel. Therefore, when the steering angle is small or the transmission torque is small, the electric motor may not be energized but does not apply any substantial resistance to the turning of the steering shaft. Therefore, the vehicle operator is prevented from receiving any undesirable interferences or reaction from the electric motor even when the steering angle is small or the transmission torque is small. This effect is particularly enhanced if a tooth thickness of the worm wheel is substantially greater than that of the worm or when teeth of at least one of the worm wheel and worm are made of plastic material.

### TECHNICAL FIELD

The present invention relates to a power steering system, and in particular to an automotive power steering system powered by an electric motor and fitted with a worm speed reduction gear unit.

### BACKGROUND OF THE INVENTION

An automotive power steering system powered by an electric motor and fitted with a worm reduction gear unit is disclosed in Japanese patent laid open (kokai) publication No. 9-132154. An electric power steering system of this type typically comprises a torque sensor for detecting the steering torque applied by the vehicle operator to the steering wheel and a control unit for activating the electric motor according to the detected steering torque so as to minimize the effort required for the vehicle operator to turn the steering wheel. The electric motor is typically PWM controlled, and the output torque of the electric motor is amplified by a worm speed reduction gear unit.

In such a worm speed reduction gear unit, the lead angle of the worm is selected in such a manner that the electric motor may be turned from the steering shaft. Thereby, the self-aligning torque can be transmitted to the steering wheel so as to facilitate the steering operation by the vehicle operator, and the steering of the vehicle may be enabled even when the electric motor fails to be energized as required. An hourglass worm is preferred because of its capability to transmit a relatively large torque for the given size of the worm.

When the torque sensor has detected a relatively large steering torque, the control unit provides a correspondingly large drive current to the electric motor, and a relatively large drive torque that is required to turn the steering shaft is produced. However, when the steering torque detected by the torque sensor is relatively small, the control unit provides very little or no drive current to the electric motor, and the electric motor is turned by the steering shaft more than the electric motor turns the steering shaft. In this case, the vehicle operator is required to provide a steering torque which is given as a sum of the torque required to turn the road wheels, friction torque of the electric motor, and viscous and inertial resistances that are present in the steering system Therefore, according to the conventional arrangement, when changing the driving lane, for instance, the vehicle operator may experience a certain reaction from the steering wheel due to the forced rotation of the motor armature, and it may impair the smoothness in turning the steering wheel. In particular, when the steering angle is small, the vehicle operator may feel a certain resistance in turning the steering wheel, and this resistance may cause an unfavorable impression to the vehicle operator.

### BRIEF SUMMARY OF THE INVENTION

In view of such problems of the prior art, a primary object of the present invention is to provide an electric power steering system using a worm gear mechanism which would not impair the feel of the steering operation in a range where the electric motor provides very little or no power assist.

A second object of the present invention is to provide an electric power steering system using a worm gear mechanism which allows a lane change or other maneuver involving a relatively small steering angle to be executed in a highly smooth manner.

A third object of the present invention is to provide an electric power steering system using a worm gear mechanism which can provide a favorable steering wheel reaction without requiring any significant modification to the existing power steering system structure.

According to the present invention, such objects can be accomplished by providing an electric power steering system comprising a worm wheel functionally connected to a steering shaft, an hourglass worm meshing with said worm wheel, and an electric motor functionally connected to said worm, wherein: a pitch diameter of said worm wheel is smaller than that of said hourglass worm.

Thus, when the transmission torque between the worm and worm wheel is relatively small, only one or two of the teeth of the worm wheel engage the worm, and a certain resiliency is produced in the meshing between the worm and worm wheel. Therefore, when the steering angle is small or the transmission torque is small, the electric motor may not be energized but does not apply any substantial resistance to the turning of the steering shaft. Therefore, the vehicle operator is prevented from receiving any undesirable interferences or reaction from the electric motor even when the steering angle is small or the transmission torque is small.

This effect is particularly enhanced if a tooth thickness of the worm wheel is greater than that of the worm or when teeth of at least one of the worm wheel and worm are made of plastic material. Typically, a lead angle of the worm is selected in such a manner that the worm may be turned from the worm wheel.

According to a particularly preferred embodiment of the present invention, the electric power steering system is incorporated in a rack and pinion steering gear system, and the steering shaft is directly connected to a pinion of the rack and pinion steering gear system. Preferably, the worm wheel is directly mounted on the steering shaft. These features contribute to the achievement of a steering gear system which is relatively free from inertia mass, and is therefore highly responsive. This advantage, combined with the stable behavior of the steering system near the neutral position thereof, provides a highly desirable steering gear system.

### BRIEF DESCRIPTION OF THE DRAWINGS

Now the present invention is described in the following with reference to the appended drawings, in which:

FIG. 1 is a schematic overall view of a steering system to which the present invention is applied;

FIG. 2 is a sectional view of an electric power steering system embodying the present invention;

FIG. 3 is a sectional view taken along line III-III of FIG. 2; and

FIG. 4 is a fragmentary enlarge view of the worm and worm wheel.

### DETAILED DESCRIPTION OF THE PREFERRED EMBODIMENTS

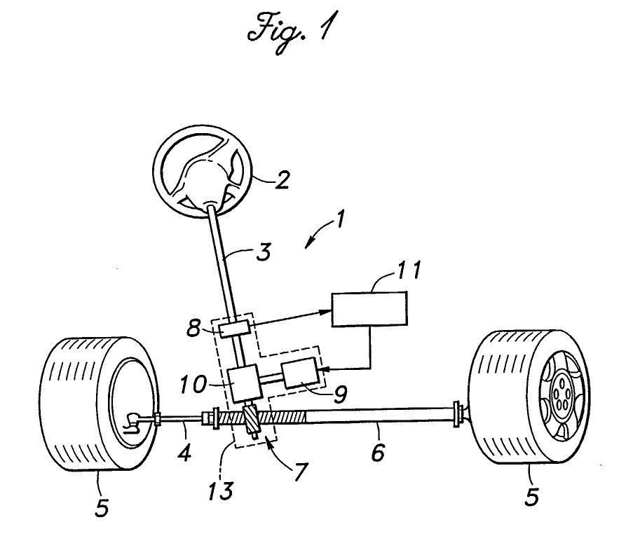

FIG. 1 schematically shows a steering system fitted with an electric power steering system embodying the present invention. This power steering system 1 comprises a steering shaft 3 having a steering wheel 2 fixedly attached to an upper end thereof, a rack shaft 6 connected to front road wheels 5 via tie rods 4, a rack and pinion mechanism 7 for converting the rotational motion of the lower end of the steering shaft 3 to an axial movement of the rack shaft 6, a magnetostrictive torque sensor 8 for detecting the steering torque applied to the steering shaft 3, an electric motor 9 for selectively applying an assist steering torque to the steering shaft 3, a worm reduction gear unit 10 for amplifying the output torque of the electric motor 9, and a control unit 11 for controlling the output of the electric motor 9 according to the output of the torque sensor 8. Thus, the steering torque which the vehicle operator applies to the steering wheel 2 is detected by the torque sensor 8, and the control unit 11 supplies a corresponding PWM controlled drive current to the electric motor 9 so that a desired steering property may be obtained in dependence on the output from the torque sensor 8.

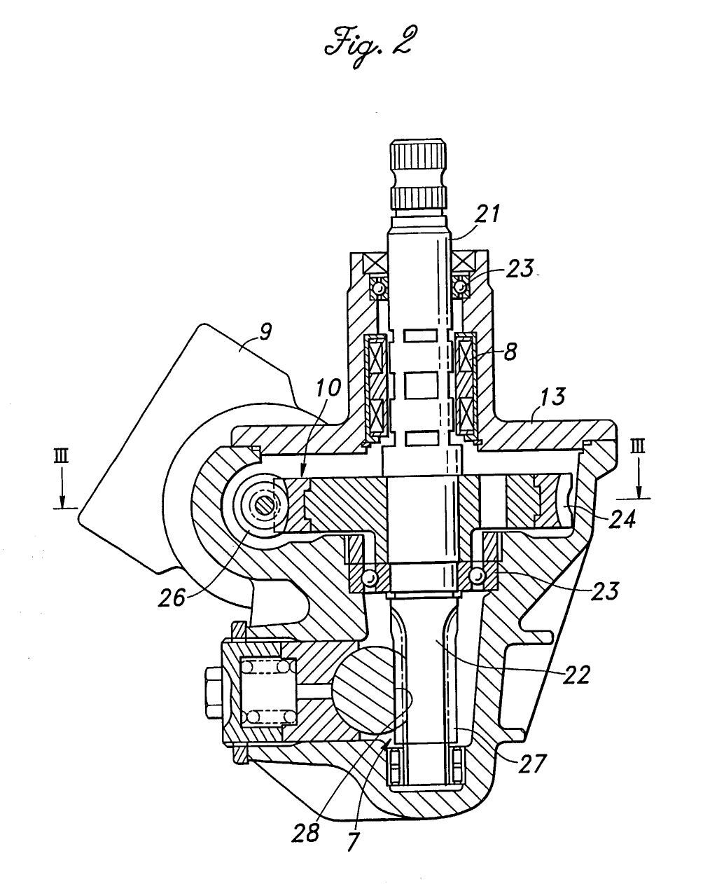

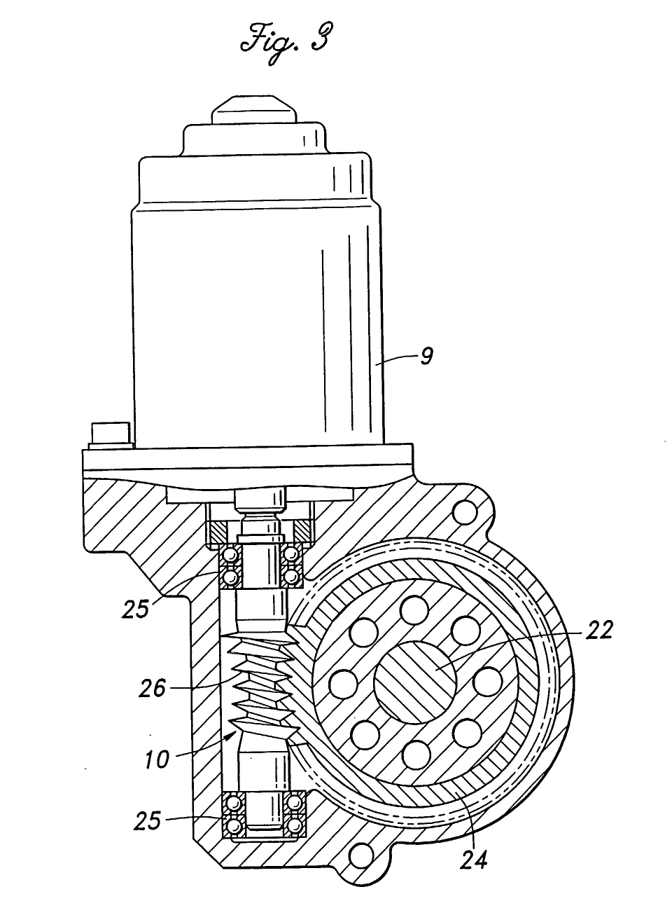

Referring to FIGS. 2 and 3, the electric power steering system 12 comprises a casing 13 which receives the rack and pinion mechanism 7, torque sensor 8 and worm reduction gear unit 10 therein. The casing 13 supports an input shaft 21 integrally connected to the steering shaft 3 via ball bearings 23. The end of the input shaft 21 remote from the steering shaft 2 is formed as a pinion shaft 22. The torque sensor 8 is attached to the casing 13, and opposes recesses formed in the input shaft 21. A worm wheel 24 is fixedly fitted on an intermediate part of the input shaft 12.

The output shaft of the electric motor 9, extending perpendicularly with respect to the input shaft 12, is formed with an hourglass worm 26 which meshes with the worm wheel 24, and is supported by the casing 13 via ball bearings 25.

Thus, the output torque of the electric motor 9 is amplified by the gear ratio defined between the worm wheel 24 and hourglass worm 26, and is transmitted to the pinion shaft 22. The pinion shaft 22 is formed with a pinion 27 which meshes with a rack 28 formed on the rack shaft 6. The torsional deformation of the input shaft 21 is detected by the torque sensor 8 as a steering torque. The operation of the control unit 11 is based on any per se known control principle, and is therefore not described in this disclosure.

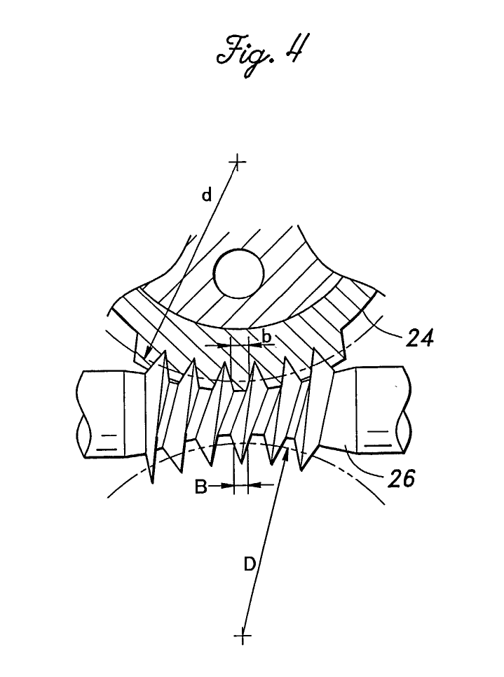

Conventionally, the pitch diameter d of the worm wheel 24 is identical to the pitch diameter D of the hourglass worm 26. However, according to the present invention, d<D. The tooth thickness b of the worm wheel 24 is related to the tooth thickness B of the hourglass worm 26 in such a manner that B<b (see FIG. 4).

According to the present invention, because d<D, the hourglass worm 26 fully engages only one or two of the teeth of the worm wheel 24. However, when a certain level of torque is applied to the worm 26, the teeth (ridge) of the worm 26 resiliently deforms or deflects, and therefore substantially fails to transmit the torque. It also means that the reaction from the electric motor 9 fails to be transmitted to the steering shaft 3. In other words, owing to the fact that d<D and the teeth of the worm 26 has a certain flexibility, a resilient play is produced between the worm and worm wheel, and the rotational resistance of the electric motor 9 would not be substantially transmitted to the steering shaft 3 over a certain angular movement of the steering shaft 3. In particular, if B<b, this tendency is even more enhanced owing to the increased flexibility of the teeth of the worm 26. Therefore, the steering can be effected in a smooth manner without being interfered by the resistance from the electric motor. When a large torque is applied to the steering shaft 3, the teeth of the worm resiliently deform in such a manner that the meshing between the worm and worm wheel is effected by a larger number of teeth. Also, the increased resiliency of the worm is beneficial also for avoiding the damage to the worm when a large kick back torque is applied to the steering shaft from an obstruction on the road surface or other causes of road kick back.

If desired, the worm wheel may be made of plastic material for an increased flexibility of the teeth thereof. In such a case, either the entire worm wheel may be made of plastic material or only outer circumferential part of the worm wheel may be made of plastic material while the remaining part is made of metal such as steel, brass and so on. It is also possible to form the worm with plastic material while the worm wheel is made of metallic material. Such combinations of materials are also beneficial in accommodating any dimensional errors that may be present between the worm and worm wheel, and simplify the manufacturing process.

Although the present invention has been described in terms of a preferred embodiment thereof, it is obvious to a person skilled in the art that various alterations and modifications are possible without departing from the scope of the present invention which is set forth in the appended claims.

1. An electric power steering system comprising a worm wheel functionally connected to a steering shaft, an hourglass worm meshing with said worm wheel, and an electric motor functionally connected to said worm, wherein:
a pitch diameter of said worm wheel is smaller than that of said hourglass worm.

2. An electric power steering system according to claim 1, wherein a tooth thickness of said worm wheel is greater than that of said worm.

3. An electric power steering system according to claim 1, wherein teeth of at least one of said worm wheel and worm are made of plastic material.

4. An electric power steering system according to claim 1, wherein a lead angle of said worm is selected in such a manner that said worm may be turned from said worm wheel.

5. An electric power steering system according to claim 1, wherein said electric power steering system is incorporated in a rack and pinion steering gear system.

6. An electric power steering system according to claim 5, wherein said steering shaft is directly connected to a pinion of said rack and pinion steering gear system, and said worm wheel is directly mounted on said steering shaft.

7. An electric power steering system according to claim 1, wherein said worm wheel is directly mounted on said steering shaft.
